(19) United States
(12) Patent Application Publication
(10) Pub. No.: US 2024/0322627 A1
(43) Pub. Date: Sep. 26, 2024

(54) SWITCHING DEVICE FOR AN ELECTRIC MOTOR AND AN ELECTRIC MOTOR COMPRISING SAID SWITCHING DEVICE

(71) Applicant: ELDOR CORPORATION S.P.A., Orsenigo (Como) (IT)

(72) Inventors: Michele ROMAN, Orsenigo (Como) (IT); Gabriele MINGIONE, Orsenigo (Como) (IT); Luca ZAI, Orsenigo (Como) (IT); Pasquale FORTE, Orsenigo (Como) (IT)

(21) Appl. No.: 18/574,726

(22) PCT Filed: Jun. 27, 2022
(86) PCT No.: PCT/IB2022/055936

§ 371 Date: Dec. 27, 2023

(30) Foreign Application Priority Data
Jun. 30, 2021 (IT) 102021000017144

(51) Int. Cl. H02K 3/28; H02P 25/18

(52) U.S. Cl. CPC H02K 3/28; H02P 25/188; H02K 2213/09

(57) ABSTRACT

A switching device for an electric motor including at least one fixed portion equipped with a number of connecting elements that can be joined to the terminals of each phase, at least one first moveable portion that can be moved with respect to the fixed portion between at least one first position in which the phases are in a first electrical configuration and at least one second position, in which it is disconnected from the phases, at least one second moveable portion that can be moved with respect to the fixed portion between at least one first position in which the phases are in a second electrical configuration, separate from the first, and at least one second position, wherein it is disconnected from the phases, and a movement unit linked to the first and to the second moveable portions and which can be selectively switched, depending on the operating conditions of said electric motor, between at least a first configuration, in which the first moveable portion is placed in the first position and the second moveable portion is in the second position, and a second configuration, in which the first moveable portion is placed in the second position and the second moveable portion is in the first position.

This invention concerns a switching device for an electric motor and an electric motor comprising said switching device.

This invention finds, therefore, special application in the automotive sector, in particular in the design and manufacture of electric or endothermic-electric hybrid vehicles.

In relation to this sector, there has a long been a wish to extend the efficiency range of the electric motor in order to allow the use of the same even in the absence of mechanical transmission, or, in any case, in the presence of a simplified mechanical transmission.

Today, some methods are known, suitable for traction applications, that exploit a suitable division of the stator winding into different sections that can be selectively combined between them in order to vary the motor “configuration”, thus adapting it to the working conditions and extending its operating range.

One of these solutions, perhaps the first, was devised by Eckart Nipp in his doctorate thesis in 1999, in which a reconfigurable electric machine that could obtain good performance in various operating conditions was described.

This solution, only illustrated on paper, found limited application on the market, mainly due to its implementation/construction difficulties.

Until today, in fact, E. Nipp's idea has been developed and created by equipping motors with complex wiring, relays, and/or solid state devices, whose main drawbacks are identified in the bulk, cost, and, in the case of solid state devices, losses that they introduce into the system.

For example, the publication WO2018/087689 illustrates a reconfigurable electric machine in which the winding of each stator phase consists of a number of coils connected together using a series of switches that, when suitably controlled, can connect in series or parallel between the coils.

Disadvantageously, the presence of numerous switches (at least 6!) to drive independently between them makes the structure of the stator particularly complex and costly, as well as not very reliable in the light of the multiplicity of non-redundant elements.

Similar considerations may be made for other publications, such as, for example, U.S. Pat. No. 8,415,910 and WO2013/155601, in which variable configuration electric machines equipped with several switches (at least 3 per phase), thanks to which each phase can change configuration.

In order to avoid these drawbacks, the same applicant filed, in 2018, an international patent application WO2020/194230 in which a solution that was much more efficient than the previous ones, at least in terms of ease of driving and loss reduction, was described.

This solution, in any case, presented some residual limitations concerning the overall integration of the device and a certain architectural rigidity of the actuation system and contacts, the reason for which the applicant decided to study new solutions that could allow them to maintain the same advantages, in terms of efficiency, while increasing the flexibility thereof.

The purpose of this invention is, thus, to provide a switching device for an electric motor avoiding the drawbacks of the above-mentioned prior art.

In particular, the purpose of this invention is to provide a switching device for an electric motor that is highly efficient and robust, having, at the same time, reduced dimensions.

In addition, the purpose of this invention is to provide a switching device for an electric motor that is highly versatile and easy to maintain.

Said purposes are achieved with a switching device having the technical features listed in one or more of the following claims.

The electric motor comprises at least a first and a second phase extending between respective terminals.

Each phase is preferably provided with at least a first phase fraction and at least a second phase fraction each extending between two ends.

Each terminal preferably corresponds to an end of a first or a second phase fraction.

The switching device preferably comprises a fixed portion equipped with multiple connecting elements that can be joined to the ends of the first and second phase fraction of each phase and/or to the terminals of each phase.

At least one first moveable portion is joined to the fixed portion and can be moved in relation to it between at least a first and a second position.

In the first position, the first moveable portion preferably has the phases in a first electrical configuration.

In the second position, the first moveable portion is preferably disconnected from the phases.

At least one second moveable portion is joined to the fixed portion and can be moved in relation to it between at least a first and a second position.

In the first position, the second moveable portion preferably has the phases in a second electrical configuration.

In the second position, the second moveable portion is preferably disconnected from the phases.

The first and the second electrical configuration are, preferably, respectively defined by a configuration of the phase fractions in series and parallel.

Alternatively, these first and second electrical configurations could be defined by a star and a triangle connection of the phases.

In an additional alternative, the switching device comprises four moveable portions that can be moved independently of each other to define at least four electrical configurations, preferably star-series and star-parallel, triangle-series, triangle-parallel.

In addition, the switching device preferably comprises a movement unit joined to said first and second moveable portions and which can be selectively switched, depending on the operating conditions of said electric motor, between a first configuration and a second configuration.

In the first configuration, the movement unit places the first moveable portion in the first position and the second moveable portion in the second position.

In contrast, in the second configuration, the movement unit places the first moveable portion in the second position and the second moveable portion in the first position.

Advantageously, the presence of a movement unit independently joined to moveable portions makes it possible, on the one hand, to make the movement efficient, by actuating just one element instead of several, and, on the other hand, facilitates the design of the device since the number and type of moveable portions can be selected arbitrarily depending on the type of machine.

In addition, the movement unit is preferably coupled to said first and second moveable portions and configured to actively move them between the first and second positions.

The term “actively” is intended, in this text, to indicate that it is the movement unit that, during its movement between the first and second configuration, imparts the respective movement between the first and second position to the moveable portions.

Advantageously, in this way, you avoid the presence of elastic return systems or independent return systems that, in addition to being subject to wear, could lead to safety issues linked to a contemporary arrangement of several electrical configurations.

In addition, the movement unit is preferably coupled to said first and second moveable portions by means of a rolling contact.

Advantageously, in this way, you avoid the need for sliding contacts or connections that, over time, are definitely subject to wear and definitely less robust.

In this regard, the first and said second moveable portions preferably have contact elements that can move closer to and further from respective contact zones of the fixed portion; this movement preferably occurs along a direction orthogonal to a striking surface of each contact zone.

Advantageously, the presence of contacts via simple abutment, again without sliding contacts or connections, reduces wear and encourages the system's increased robustness.

In this regard, there are, preferably, elastic means (or alternative presser systems) joined to the contact elements and/or the respective contact zone, which are designed to ensure a correct contact force between the respective moveable portion and the fixed portion.

These elastic means have the advantage of requiring a minimum stroke, being less subject to wear compared to complete elastic return means, having the sole purpose of ensuring the maintenance of a sufficient contact force between the conductors of the moveable portion and the fixed portion, without, thus, impacting the reliability and durability of the system.

These elastic means are preferably movably installed on the fixed portion (or any moveable portions) in order to be replaceable, a very useful feature during calibration, for the automatic compensation of wear or coupling tolerances or to facilitate a standardisation of different device models.

The movement unit preferably rotates around said central axis between a first angular position, corresponding to the first configuration, and a second angular position, corresponding to the second configuration, and vice versa.

In the case of several configurations, there could also be more than two angular positions.

The movement unit is, more preferably, configured to move the first and second moveable portions along respective axial directions, parallel to said central axis, between respective raised positions, corresponding to the second positions, and respective lowered positions, in contact with the fixed portion and corresponding to the first positions.

Advantageously, this configuration makes it possible, at the same time, to optimise the generation of contacts and reduce the device's overall size.

In fact, both the moveable portions preferably have a maximum stroke that extends from the same first level, raised in relation to the fixed portion, to a second level in contact with the fixed portion.

In this way, both the axial dimensions of the device and the connection complexity are minimal, since the movement of the movement unit is only circumferential and the positioning of the moveable portions, being circumferentially unbound from the angular position of the movement unit, simplified.

The switching device preferably comprises a rotary or linear actuator and a rotating body, preferably a ring or disc, connected to said rotary actuator.

The rotating body can be moved between a first and second angular position, corresponding to said first and second configuration.

The rotating body has one or more first cam profiles and one or more second cam profiles.

The first cam profiles are slidably joined to said first moveable portion so they can move it between the first and second positions following a rotation of the ring between the first and second angular position.

The second cam profiles are slidably joined to said second moveable portion so they can move it between the first and second positions following a rotation of the ring between the first and second angular positions.

The first and second cam profiles are preferably defined by respective grooves.

The first and second moveable portions more preferably, comprise corresponding movement carriages, slidably attached to the corresponding groove by means of a rolling contact, preferably using bearings, which can preferably be moved independently of each other.

These and other features, together with their relative technical advantages, will be clearer from the following exemplary, and therefore non-limiting, description of a preferred, and therefore not exclusive, embodiment of a switching device for an electric motor, according to what is illustrated in the attached figures, wherein:

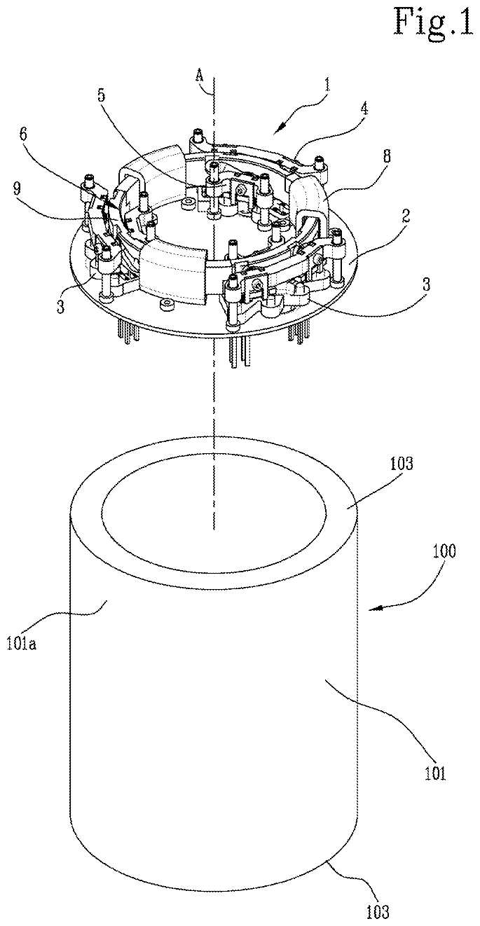

FIG. 1 shows a schematic, exploded view of an electric motor provided with a switching device according to this invention;

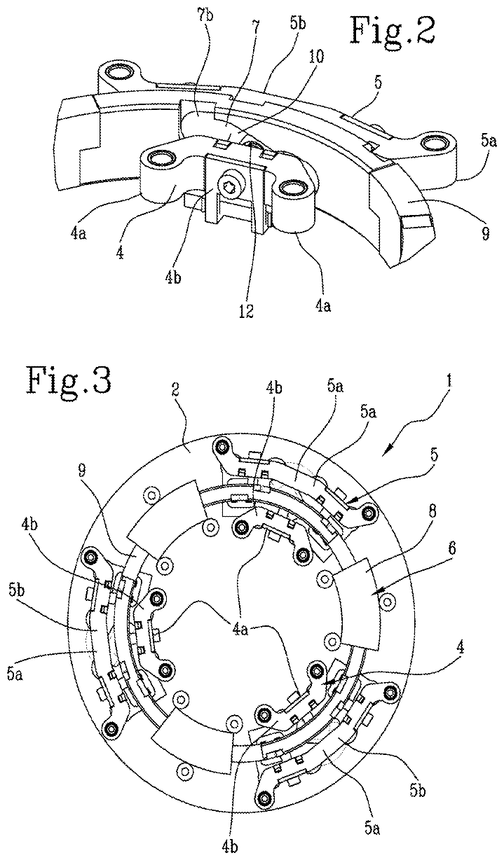

FIG. 2 shows a detail of FIG. 1;

FIG. 3 shows a plan view of the switching device in FIG. 1;

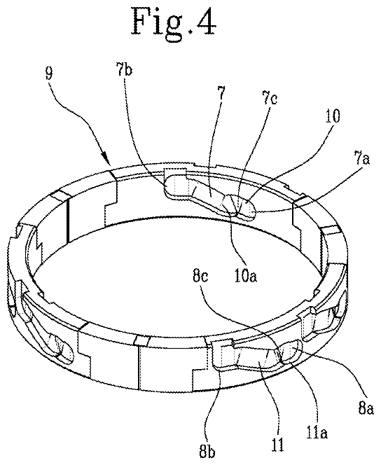

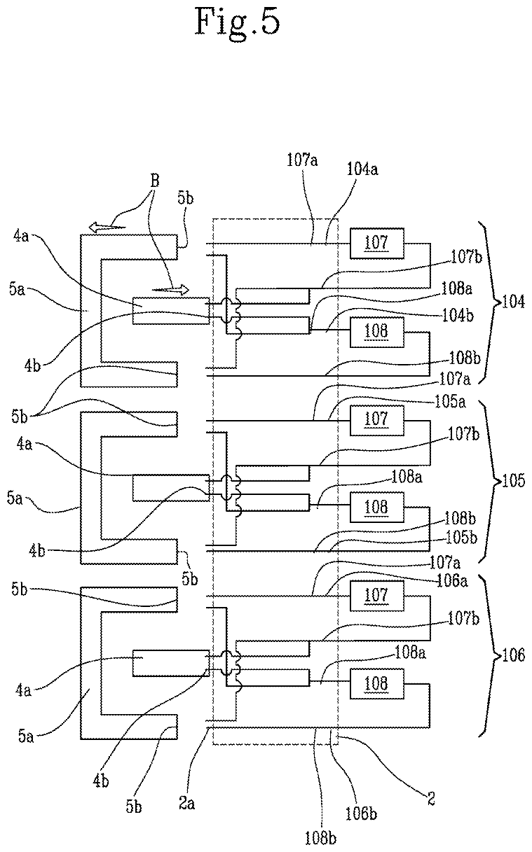

FIG. 4 shows a perspective view of a component of the device in FIG. 1;

FIG. 5 shows an electrical diagram representing a preferred embodiment of the electric motor and of the switching device in FIG. 1.

With reference to the attached figures, the reference number 1 denotes a switching device for an electric motor 100 in accordance with this invention.

The switching device 1 is, thus, connected or able to be connected to an electric motor 100, preferably but not exclusively of the internal magnet type.

In particular, the electric motor 100 comprises a stator body, or stator 101, and a rotor body, or rotor rotatably connected to the stator 101 to rotate around its own rotation axis “A”.

The rotor 102 is preferably inserted in the stator 101 coaxially to it, at least to the stator cavity, and comprises multiple magnets, electromagnets, or windings designed to generate a magnetic field.

The stator 101, in turn, is provided with a casing 101a (prismatic, preferably cylindrical) extending along said rotation axis “A” between two end faces 103.

This casing 101a contains multiple phases 104, 105, 106 angularly spaced apart and defined by corresponding windings.

The phases may be of various kinds, but are preferably defined by bar conductors suitably arranged in corresponding hollows made in the casing and electrically connected together at least one free end (i.e. near an end face 103a of the casing 101a).

The electric motor 100 is, thus, a multiphase one, i.e. comprising a number of phases that go from two upwards depending on the type or application.

In the preferred embodiment, in any case, the electric motor 100 is at least a three-phase electric motor.

In other words, in the embodiment illustrated (merely by way of example), the stator 101 comprises at least a first 104, second 105, and third phase 106.

Each phase 104, 105, 106 extends between corresponding first 104a, 105a, 106a and second terminals 104b, 105b, 106b.

In the embodiment illustrated, the electric motor 100 preferably has fractionated phases.

Thus, each phase 104, 105, 106 is preferably provided with at least one first phase fraction 107 and at least one second phase fraction 108, both extending between a first end 107a, 108a and a second end 107b, 108b.

It should be noted, in this respect, that one end 107a of the first phase fraction 107 and one end 108b of the second phase fraction 108 correspond to the terminals 104a, 104b, 105a, 105b, 106a, 106b of the phases 104, 105, 106.

More precisely, the first end 107a of the first phase fraction 107 and the second end 108b of the second phase fraction 108 correspond, respectively, to the first 104a, 105a, 106a and to the second terminal 104b, 105b, 106b of the corresponding first 104, second 105, or third phase 106.

In other words, each terminal 104a, 104b, 105a, 105b, 106a, 106b corresponds to an end 107a, 108b of a first 107 or a second phase fraction 108.

The phase fractions 107, 108 of each phase 104, 105, 106 are, as mentioned, coils or, preferably, bars (or sets of bars/hairpins) connected to each other.

According to the invention, the phases 104, 105, 106 and/or phase fractions 107, 108 of each phase may be suitably connected together to vary the operating configuration of the electric motor 100.

In this regard, the invention involves a switching device 1 comprising a fixed portion 2 equipped with a number of connecting elements 3 that can be joined to the ends 107a, 108a, 107b, 108b of the first 107 and second phase fraction 108 and/or to the terminals 104a, 104b, 105a, 105b, 106a, 106b of each phase 104, 105, 106.

This fixed portion 2 preferably comprises at least one support rigidly connected to the windings of the electric machine and connected to the connecting elements 3; in these embodiments, the fixed portion could comprise several supports, each connected, via the connecting elements 3, to the ends or terminals of an individual phase 104, 105, 106.

In this respect, the phases 104, 105, 106 of the stator preferably comprise multiple conductor packs in series inside, arranged according to a prefixed winding design and extending, each one, between two free ends.

The fixed portion 2 (i.e. each support or element of the fixed portion 2) is preferably shaped to receive inside said free ends of the conductor packs in series.

More preferably, the fixed body comprises inside at least one conducting portion shaped to connect the free ends of two or more conductor packs in parallel with each other.

In one preferred embodiment, the fixed portion 2, in particular the supports and/or the connecting elements 3 are made in the form of busbars in order to define the electrical connection between conductor packs of the electric motor 100 winding.

More preferably, the stator 101 of the electric motor 100 comprises a multitude of bar conductors suitably coupled with each other so as to define multiple conductor packs in series extending between respective free ends projecting outside the casing 101a.

Therefore, the fixed portion 2 of the switching device 1 is operationally placed between the stator 101 and the moveable body 2 and shaped to receive the free ends of the conductor packs in series.

The switching device 1 also comprises at least one first moveable portion 4 and at least one second moveable portion 5.

The first moveable portion 4 that can be moved with respect to the fixed portion 2 between at least one first position in which the phases 104, 105, 106 are in a first electrical configuration and at least one second position, in which it is disconnected from the phases 104, 105, 106.

The second moveable portion 5 can, instead, be moved with respect to the fixed portion 2 between at least one first position in which the phases 104, 105, 106 are in a second electrical configuration, separate from the first, and at least one second position, wherein it is disconnected from the phases 104, 105, 106.

The first and the second moveable portion 4, 5 are, thus, physically independent of each other, each provided with suitable contacts designed to arrange the ends or terminals of the phases in the first or second configuration and able to be selectively moved in the corresponding first and second positions.

According to one aspect of the invention, the device comprises a movement unit 6 connected to the first 4 and to the second moveable portion 5.

The movement unit 6 can be selectively switched, depending on the operating conditions of said electric motor 100, between at least one first and at least one second configuration.

In the first configuration, the movement unit 6 places the first moveable portion 4 in the first position and the second moveable portion 5 in the second position.

In the second configuration, the movement unit 6 places the first moveable portion 4 in the second position and the second moveable portion 5 is in the first position.

In other words, the movement unit 6 is an element connected to the first 4 and to the second moveable portion 5, operationally placed between the moveable portions 4, 5 and the fixed portion 2 and configured to move, alternatively and/or independently, the moveable portions 4, 5 thus moving between the first and second configuration.

More precisely, the movement unit 6 is coupled to said first 4 and second moveable portions 5 and preferably configured to actively move them between the first and second positions.

Advantageously, this solution makes it possible to independently and actively move both portions, ensuring that the two portions are never in the first position at the same time, making the system simple, quick, and reliable at once.

In addition, the movement unit 6 is preferably coupled to said first 4 and second moveable portion 5 by means of a rolling contact.

In other words, each moveable portion 4, 5 has one or more contact elements rotatably connected to the movement unit 6.

Advantageously, in this way, friction is basically eliminated, reducing both the wear of the components and the over-heating of the system.

The movement unit 6 preferably comprises at least a first guide 7 and a second guide 8 shaped to translate the first 4 and second moveable portions 5, respectively, between the first and second positions, and vice versa, when the movement unit 6 moves between the first and second configurations.

More precisely, the first guide 7 is shaped so as to translate the first moveable portion 4 from the first to the second position in response to a movement of the movement unit 6 from the first to the second configuration, and vice versa.

Similarly, the second guide 8 is shaped so as to translate the second moveable portion 5 from the first to the second position in response to a movement of the movement unit 6 from the second to the first configuration, and vice versa.

The guides 7, 8 are, thus, moveable along a motion direction of the movement unit 6 and shaped to transform said motion into a translation of the first 4 and of the second 5 moveable portion.

It should be noted that each guide 7, 8 extends at least between a first section 7a, 8a and a second section 7b, 8b.

When the moveable portion 4, 5 is at the corresponding first section 7a, 8a, the moveable portion is positioned in the first position.

When the moveable portion 4, 5 is at the corresponding second section 7b, 8b, the moveable portion is positioned in the second position.

In this respect, it should be noted that the two guides 7, 8 extend, in relation to the motion direction of the movement unit, in opposing directions, in order to move, alternatively, the first 4 and the second 5 moveable portion.

It should be noted that the movement of the first 4 and of the second moveable portion 5 is preferably a linear movement approaching and moving away from the fixed portion 2.

Thus, the first 4 and the second moveable portion 5 have corresponding contact elements 4b, 5b that can move closer to and further from respective contact zones 2a of the fixed portion 2 between the first and second position.

In this respect, preferably, each moveable portion 4, 5 comprises at least three contact elements 4b, 5b angularly spaced between them so as to couple each with a stator phase 104, 105, 106.

It should be noted that the contact elements 4b, 5b of each moveable portion 4, 5 could be attached to each other using a single support/body, or be physically independent of each other.

This last option is particularly advantageous for the purposes of reducing the dimensions and, at the same time, enabling the insertion of several moveable portions independent of each other.

In the preferred embodiment, the movement unit 6 rotates around a central axis A and is configured to transform a rotational movement of its own into a linear translation of said first 4 and said second moveable portions 5.

Advantageously, this makes it possible to make the system compact and, at the same time, highly efficient and reliable.

In this respect, the movement unit 6 preferably rotates around said central axis “A” between a first angular position, corresponding to the first configuration, and a second angular position, corresponding to the second configuration, and vice versa.

Said first 7 and second guide 8 are, thus, defined by circumferential paths extending between sections arranged at different levels (axial or radial), in order to move the corresponding moveable portions 4, 5 between the first and second position.

It should be noted that the linear movement of the moveable portions 4, 5 preferably extends along an axial direction, parallel to the rotation axis “A”.

Thus, preferably, the movement unit 6 is configured to move the first 4 and the second moveable portion 5 along an axial direction “B” parallel to said rotation axis “A”.

More precisely, the moveable portions 4, 5 can be moved between respective raised positions, corresponding to the second positions, and respective lowered positions, in contact with the fixed portion 2 and corresponding to the first positions.

In this respect, thus, the contact elements 4b, 5b of the first 4 and second moveable portion 5 can move closer to and further from respective contact zones 2a of the fixed portion 2 along a direction orthogonal B to a striking surface of each contact zone 2a.

In addition, each first 7 and second guide 8 of the movement unit 6 preferably comprises at least one retaining portion 7c, 8c, placed at the respective first section 7a, 8a.

This retaining portion 7c, 8c is defined by a shape or a processing of the corresponding guide 7, 8 shaped to retain the respective moveable portion 4, 5 in the first position, even in the absence of an active action by the movement unit 6 (i.e. passive detent).

Advantageously, this makes it possible to reduce the energy consumption required by the actuation system of the movement unit 6.

In this respect, the movement unit 6 preferably comprises a linear or rotary actuator 8, connected to a rotating body 9, preferably a ring, on which said first 7 and second guide 8 are made.

The rotating body 9 is, thus, attached to the first 4 and to the second moveable portion 5 at least at the first 7 and second guide 8 in order to translate them between the first and second position in response to a movement of the actuator 8.

Said actuator 8, thus, is configured to rotate the rotating body 6 between at least one first and one second angular position.

The actuator 8 is preferably defined by a rotary actuator, but, alternatively, it could also be defined by one or more linear actuators connected to the rotating body via a transmission system designed to rotate it.

In an additional embodiment, moreover, the actuator 8 could be defined by one or more linear motors, wherein the carriages are anchored to the casing 101a of the stator 101 and the linear guide has a circumferential shape.

In the preferred embodiment, the rotating body 9 has one or more first cam profiles 10 and one or more second cam profiles 11.

The first cam profiles are slidably joined to said first moveable portion 4 so they can move it between the first and second positions following a rotation of the rotating body 9 between the first and second angular position.

The second cam profiles are slidably joined to said second moveable portion 5 so they can move it between the first and second positions following a rotation of the rotating body between the first and second angular positions.

The first 10 and the second cam profile 11, preferably, respectively define the first 7 and the second guide 8 described above.

More preferably, then, these cam profiles 10, 11 are slidably connected, via a rolling contact, to the respective moveable portions 4, 5.

In particular, the first 4 and the second moveable portion 5 comprise movement carriages 4a, 5a slidably attached to the corresponding cam profile, preferably via bearings 12 or other rolling contact means.

In the preferred embodiment, said one or more first 10 and second cam profiles 11 are defined by respective grooves 10a, 11a, inside of which the bearings of each carriage can rotate.

In this way, each carriage can simply slide inside the groove, preventing, at the same time, its detachment.

As already mentioned, the rotating body 9 is preferably defined by a ring that delimits a radially internal zone and a radially external zone.

The first moveable portion 4 is preferably positioned radially external to said ring 9 (i.e. in the radially internal zone) and the second moveable portion 5 is positioned radially internal to said ring 9 (i.e. in the radially external zone).

In this respect, the grooves 10a, 11a are preferably made respectively on one radially internal face and on one radially external face of the ring, to the advantage of the axial compactness of the device.

In addition, there are, preferably, elastic means (not illustrated) or alternative presser systems joined to the contact elements 4a, 5a and/or the respective contact zone 2a, which are designed to ensure a correct contact force between the respective moveable portion 4, 5 and the fixed portion 2.

These elastic means have the advantage of requiring a minimum stroke, being less subject to wear compared to complete elastic return means, having the sole purpose of ensuring the maintenance of a sufficient contact force between the conductors of the moveable portion and the fixed portion, without, thus, impacting the reliability and durability of the system.

In addition, these elastic means are preferably movably installed on the fixed portion (or any moveable portions) in order to be replaceable, a very useful feature during calibration, for the automatic compensation of wear or coupling tolerances or to facilitate a standardisation of different device models.

It should be noted that, in the description up to this point, the presence of at least two electrical configurations, at least two moveable portions, and at least two configurations of the movement unit have been mentioned.

These two electrical configurations are preferably defined by an arrangement, in series, and an arrangement, in parallel, of the phase fractions or by a triangle or star arrangement of the phases.

In any case, the spirit of this invention also encompasses solutions wherein there are more than two configurations, like the positions of the movement unit and/or the moveable portions.

In some embodiments, there could be four positions of the movement unit, like the moveable portions, so as to enable the definition of four different electrical configurations, i.e.: star-series, star-parallel, triangle-series, and triangle-parallel.

Advantageously, being able to distribute, circumferentially, multiple moveable portions, for example, four moveable portions coupled in twos (series-parallel and star-triangle) and distributed with three contact elements each, a switching device 1 that is equally compact and versatile, able to optimise the performance of the electric machine, would be obtained.

In this respect, the switching device 1 comprises a control unit (not illustrated) connected to the movement unit 6 in order to drive them depending on the operating conditions of the electric motor 100.

This control unit (not illustrated) is preferably connected to the vehicle control unit or to sensor means able to transmit information correlated to the operating parameters of the vehicle and/or of the electric motor 100 itself.

The invention achieves the purposes proposed and entails significant advantages.

In fact, the presence of a switching device that can vary the electrical configuration of the motor with a simple movement of a single movement unit and that is suitably controllable, significantly increases the reliability of the system while simplifying it and reducing the costs thereof, both of production and maintenance.

Moreover, the presence of an active movement of two different moveable portions between different configurations makes it possible, at the same time, to maximise the efficiency and reliability of the device.

Again, the presence of a rolling contact between the moveable portions and the movement unit significantly reduces the friction in the movement of the system, limiting both the wear and over-heating of the contacts.

1. A switching device for an electric motor, said motor comprising a plurality of phases extending between their respective terminals and each preferably provided with at least one first phase fraction and at least one second phase fraction each extending between two ends, where each terminal corresponds to one end of a first or second phase fraction; said switching device being characterised in that it comprises:
at least one fixed portion equipped with a number of connecting elements that can be joined to the ends of the first and second phase fraction and/or to the terminals of each phase;
at least one first moveable portion that can be moved with respect to the fixed portion between at least one first position in which the phases are in a first electrical configuration and at least one second position, in which it is disconnected from the phases;
at least one second moveable portion that can be moved with respect to the fixed portion between at least one first position in which the phases are in a second electrical configuration, separate from the first, and at least one second position, wherein it is disconnected from the phases;
a movement unit linked to said first and said second moveable portions and which can be selectively switched, depending on the operating conditions of said electric motor, between at least:
a first configuration, in which the first moveable portion is placed in the first position and the second moveable portion is in the second position;
a second configuration, in which the first moveable portion is placed in the second position and the second moveable portion is in the first position.

2. The switching device according to claim 1, wherein said movement unit is coupled to said first and second moveable portions and configured to actively move them between the first and second positions.

3. The switching device according to claim 1, wherein said movement unit is coupled to said first and second moveable portions by means of a rolling contact.

4. The switching device according to claim 2, wherein said movement unit comprises at least one first guide and a second guide shaped to translate the first and the second moveable portions, respectively, between the first and second positions, and vice versa, when the movement unit moves between the first and second configurations.

5. The switching device according to claim 4, wherein each first and second guide of the movement unit extends at least between a first section and a second section, wherein when the first or second moveable portion is located on the respective first section, said moveable portion is placed in the first position, and when the first or second moveable portion is located on the respective second section, the moveable portion is placed in the second position; said first and second guide comprise at least one retaining portion located on the respective first section and defined by a geometry or processing of the respective guide shaped to retain the respective moveable portion in the first position even in the absence of an active action by the movement unit.

6. The switching device according to claim 1, wherein the movement unit rotates around a central axis and is configured to transform a its own rotational movement into a linear translation of said first and said second moveable portions.

7. The switching device according to claim 6, wherein the movement unit rotates around said central axis between at least a first angular position, corresponding to the first configuration, and a second angular position, corresponding to the second configuration, and vice versa.

8. The switching device according to claim 6, wherein the movement unit is configured to move the first and second moveable portions along an axial direction parallel to said central axis, between respective raised positions, corresponding to the second positions, and respective lowered positions, in contact with the fixed portion and corresponding to the first positions.

9. The switching device according to claim 1, wherein the movement unit comprises:
a rotary or linear actuator;
a rotating body, preferably a ring, connected to said actuator and moveable between a first and a second angular position, corresponding to said first and second configuration, wherein said ring has:
one or more first cam profiles joined to said first moveable portion so they can slide to move it between the first and second positions following a rotation of the ring between the first and second angular positions;
one or more second cam profiles joined to said second moveable portion so they can slide to move it between the first and second positions following a rotation of the ring between the first and second angular positions.

10. The switching device according to claim 9, wherein said one or more first and second cam profiles are defined by respective grooves.

11. The switching device according to claim 10, wherein said first and said second moveable portions comprise movement carriages bound to slide in the respective groove by means of a rolling contact, preferably by means of bearings.

12. The switching device according to claim 9, wherein the first moveable portion is placed radially external to said ring and the second moveable portion is placed radially internal to said ring.

13. The switching device according to claim 1, wherein said first and said second moveable portions have contact elements that can move closer to and further from respective contact zones of the fixed portion along a direction orthogonal to a striking surface of each contact zone.

14. The switching device according to claim 13, wherein elastic means joined to the contact elements and/or the respective contact zone are provided, which are designed to ensure a correct contact force between the respective moveable portion and the fixed portion.

15. A variable configuration electric motor, comprising:
a rotor rotatable about a first rotation axis;
a stator provided with a casing extending along said rotation axis between two end faces and containing a number of phases extending between respective terminals, in which each phase is preferably provided with at least one first phase fraction and at least one second phase fraction; said first and second phase fractions each extending between two ends, in which each terminal corresponds to one end of a first or second phase fraction;
a switching device according to claim 1, in which the fixed portion is fixed to one of said end faces of the casing.
